(19) United States
(12) Patent Application Publication
(10) Pub. No.: US 2008/0297928 A1
(43) Pub. Date: Dec. 4, 2008

(54) LOW MASS OPTICAL DEVICE AND METHOD

(76) Inventor: Devon G. Crowe, Tucson, AZ (US)

Correspondence Address: Jonathan A. Platt;Renner, Otto, Boisselle & Sklar, LLP, 19th Floor, 1621 Euclid Ave., Cleveland, OH, 44115, US

(21) Appl. No.: 11/756,645

(22) Filed: Jun. 1, 2007

(51) Int. Cl. G02B 5/08; B29D 11/00

(52) U.S. Cl. 359/857; 264/1.1; 264/1.36; 264/1.9; 359/867

(57) ABSTRACT

An optical device includes a structure defining an enclosed volume that is empty or filled with a non-solid, such as an aerogel or a gas, within which reflective surfaces bounce incoming light back and forth, focusing the light toward an exit aperture. The structure of the device may be formed from two halves, which are molded or machined to form the inner faces used to reflect and focus incoming light. The structure halves may be made of a moldable material. The moldable material may have reflective material, such as aluminum, deposited on inner faces that are used to reflect and focus incoming light. The halves of the structure are joined together, such as by use of a suitable adhesive. The enclosed volume may be substantially empty except for an ambient gas. The resulting hollow optical device provides a greatly reduced weight compared with folded optics made from solid materials.

### BACKGROUND OF THE INVENTION

1. Field of the Invention

The invention is in the general field of optical devices, and more particularly in the field of folded optical devices.

2. Description of the Related Art

Optical devices, such as lenses and mirrors, used for affecting light rays, have been employed for centuries. Folded optics have been used to reduce the size of optical devices. An example of a folded optic is disclosed in Tremblay, Eric J., et al., “Ultrathin Cameras Using Annular Folded Optics,” Applied Optics, Vol. 46, Issue 4, pp. 463-471 (2007). However, it will be appreciated that there is an ongoing desire for improvements in optical devices.

### SUMMARY OF THE INVENTION

According to an aspect of the invention a folded optic has a light path in an enclosed volume filled with a non-solid material. The non-solid material may be a gas, may be a liquid, or may be substantially a vacuum.

According to another aspect of the invention, an optical device includes: a structure defining a substantially enclosed volume, wherein the structure has an entrance aperture for receiving incoming light, and an exit aperture; and reflective surfaces on opposite walls of the structure, wherein the reflective surface reflect and focus the incoming light multiple times along a light path from the entrance aperture to the exit aperture. The enclosed volume is taken up by a non-solid.

According to yet another aspect of the invention, a method of making an optical device includes the steps of: forming a top half of the optical device structure; forming a bottom half of the optical device structure; depositing reflective material on one or more top half inner faces of the top half and one or more inner faces of the bottom half; and joining together the top half and the bottom half with the one or more top half inner faces facing the bottom half inner faces. The forming the top half includes: placing top half moldable material in contact with a top half mandrel having a shape corresponding to a desired top half inner face configuration of a top wall of the optical device; molding the top half moldable material to correspond to the shape of the top half mandrel; cooling the top half moldable material; and removing the top half moldable material from contact with the mandrel. The forming the bottom half includes: placing bottom half moldable material in contact with a bottom half mandrel having a shape corresponding to a desired bottom half inner face configuration of a bottom wall of the optical device; molding the bottom half moldable material to correspond to the shape of the bottom half mandrel; cooling the bottom half moldable material; and removing the bottom half moldable material from contact with the mandrel.

According to still another aspect of the invention, a method of handling an optical device includes the steps of: providing the optical device; filling the enclosed volume of the optical device with liquid; subjecting the optical device to a hazardous situation while still filled with the liquid; and emptying the liquid from the optical device. The optical device includes a structure defining a substantially enclosed volume, wherein the structure has an entrance aperture for receiving incoming light, and an exit aperture; and reflective surfaces on opposite walls of the structure, wherein the reflective surface reflect and focus the incoming light multiple times along a light path from the entrance aperture to the exit aperture;

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

In the annexed drawings, which are not necessarily to scale:

FIG. 1 is a cross-sectional view of an optical device in accordance with an embodiment of the invention;

FIG. 2 is an oblique view of the optical device of FIG. 1;

FIG. 3 is a high-level flow chart showing steps in the production of the optical device of FIG. 1;

FIG. 4 is a cross-sectional view showing mandrels used in the method of FIG. 3;

FIG. 5 is a cross-sectional view illustrating one step of the method of FIG. 3;

FIG. 6 is a cross-sectional view illustrating another step of the method of FIG. 3;

FIG. 7 is a cross-sectional view illustrating one configuration in employing the optical device of FIG. 1;

FIG. 8 is a cross-sectional view of an alternate embodiment optical device in accordance with the present invention.

### DETAILED DESCRIPTION

An optical device includes a structure defining an enclosed volume that is empty or filled with a non-solid, such as an aerogel or a gas, within which reflective surfaces bounce incoming light back and forth, focusing the light toward an exit aperture. The optical device provides a smaller, low-mass alternative to conventional optics. The structure of the device may be formed from two halves, which are molded or machined to form the inner faces used to reflect and focus incoming light. The structure halves may be made of a moldable material, such as a suitable plastic or glass. The moldable material may have reflective material, such as aluminum, deposited on inner faces that are used to reflect and focus incoming light. Alternatively the structure halves may be made of machined metal, which may be polished to form the reflective surfaces. The halves of the structure are joined together, such as by use of a suitable adhesive. The enclosed volume may be substantially empty except for an ambient gas. The resulting hollow optical device provides a greatly reduced weight compared with folded optics made from solid materials. In addition the hollow optical device may advantageously allow passage of a wider spectrum of light frequencies, again compared with folded optical devices made from solid materials. The hollow optical device may be filled with a suitable liquid to prevent damage during relatively hazardous situations, such as in launch of a spacecraft. The liquid may be emptied out of the optical device prior to actual use.

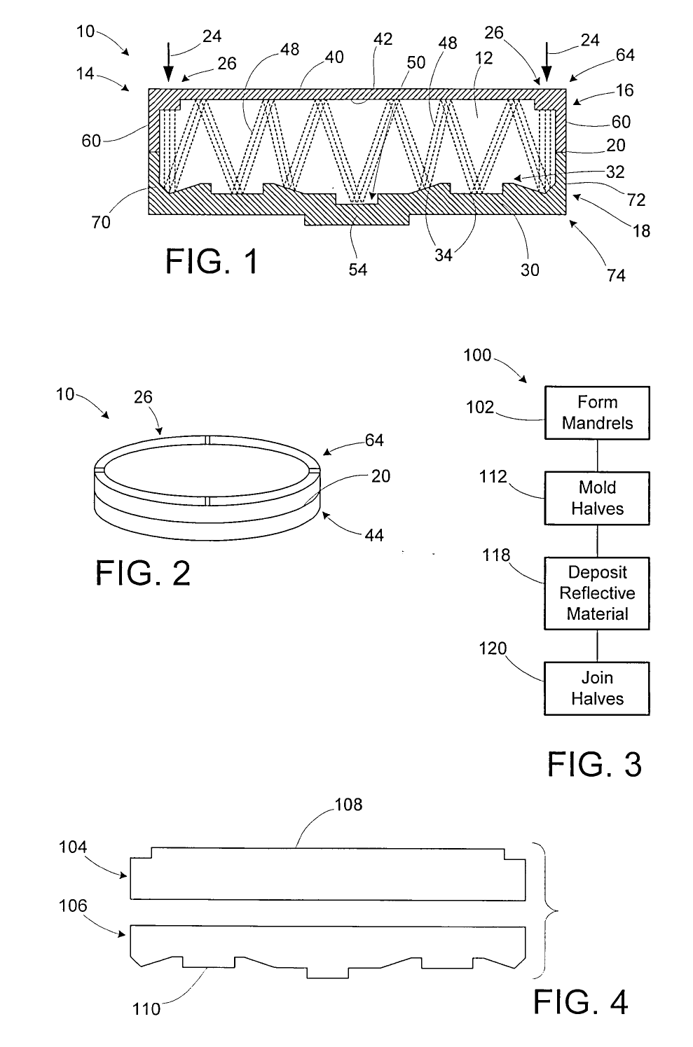

FIGS. 1 and 2 show an optical device 10 that has an enclosed or internal volume 12 that is empty or filled with a liquid or a gas. The phrase “taken up by a non-solid” is used herein to indicate a volume that has a fluid (a liquid or a gas) therein, or is substantially empty (a vacuum). One example of a non-solid is a suitable aerogel, a sold material derived from a gel, in which the liquid component of the gel has been replaced by a gas. An example of such a material an aerogel with a silica sold material, although it will be appreciated that a wide variety of sold materials may be involved.

The optical device 10 includes a structure 14 that encloses and defines the enclosed volume 12. The structure 14 includes a top half 16 and a bottom half 18, which are joined together along a join line 20. The structure 14 in the illustrated embodiment is a disc-shape structure, but it will be appreciated that other shapes may be utilized for the structure 14. The halves 16 and 18 may be adhesively joined along the join line 20, or may be joined by other suitable mechanisms.

The optical device 10 is a folded optic. Incoming light 24 enters an annular aperture 26 in the top half 16. A bottom wall 30 has a series of facets or faces 32. Bottom half reflective surfaces 34 are on some of the facets or faces 32. The top half 16 has a top wall 40 which has a flat top half reflective surface 42 running along substantially all of its length between the ends of the annular aperture 26. The top half reflective surface 42 is not angled, being substantially parallel to the bottom wall 30.

The incoming light 24 enters through the annular aperture 26. It bounces back and forth between the bottom half reflective surfaces 34 and the top half reflective surface 42, following a light path 48. As the light is reflected it is focused. Finally the focused light exits the enclosed volume through an exit aperture or opening 50. The exit aperture 50 is at the center of the bottom wall 30. A focal plane array or other image-receiving device 54 may be located at the exit aperture 50.

The top wall 40 and top sides 60 and 62 may be formed as a single piece 64. The piece 64 constitutes a substrate upon which the top half reflective surface 42 is placed. Similarly, the bottom wall 30 and bottom half sides 70 and 72 may constitute a single-piece bottom half substrate 74 upon which the bottom half reflective surfaces 34 are placed.

The top half substrate 64 and the bottom half substrate 74 may be made of suitable moldable materials. The moldable material may be a glass, such as silicon glass or another glassy state material. Alternatively, the moldable material may be a suitable polymer or epoxy material.

The reflective material for the reflective surfaces 34 and 42 may be any of a wide variety of suitable materials. Examples include metals such as aluminum, silver, gold, or combinations thereof.

The folded optic 10 may have any of a wide variety of sizes. An example embodiment has a diameter of 100 mm and a thickness of 5 mm. It is desirable, although not necessary, that the optic 10 be small enough so that no internal structure is needed within the enclosed volume 12. In other words, it is desirable that the only mechanical connection between the bottom wall 30 and the top wall 40 be along the sides 60, 62, 70, and 72 of the halves 16 and 18.

The optical device 10 may be able to handle a wide variety of light frequencies, especially when enclosed volume 12 is either a vacuum, or is filled with a gas. By having the light path 48 within the enclosed volume 12 encounter the same material as is outside the optical device 10, changes in refraction and other optical characteristics are avoided. This is in contrast to optical devices that cause light to travel through solid optical elements. Such devices may only be able to handle smaller wavelength ranges of light.

The low mass of the optical device 10 stems in large measure from its being hollow, with a non-solid such as a gas or a vacuum in the enclosed volume 12. While such a configuration does greatly reduce mass, it has the potential of sustaining damage under high loads. One example of a high-load regime is during spacecraft launch, when accelerations many times that of gravity are sustained. The danger from such hazardous conditions can be reduced at least in part by filling the enclosed volume 12 with a liquid during the hazardous period. The liquid helps support the structure 14. After the hazardous condition has been removed, such as when a launch process has been finished, the liquid filling the enclosed volume 12 may be removed. This may be done prior to operation of the optical device 10.

FIG. 3 shows some steps of a method 100 for making the optical device 10. In step 102, illustrated in FIG. 4, a top mandrel 104 and a bottom mandrel 106 are formed. The mandrels 104 and 106 have respective mandrel surfaces 108 and 110. The top mandrel surface shape 108 corresponds to an inner surface shape of the top substrate 64 (FIG. 1). The bottom mandrel surface shape 110 corresponds to the inner surface shape of the bottom substrate 74 (FIG. 1).

In step 112 of the method 100, illustrated in FIG. 5, moldable material 114 is placed on the mandrels 104 and 106, to form the substrates 64 and 74. Having the moldable material 114 conform to the surface shapes 108 and 110 involves heating the moldable material 114 above its glass transition temperature. This heating may be done by directly heating the moldable material 114, or may involve indirect heating, such as heating the mandrels 104 and 106. Indirect heating of the mandrels 104 and 106 may be done before the mandrels 104 and 106 are brought into contact with the moldable material 114. Alternatively, the heating of the mandrels 104 and 106 may be done after they are brought into contact with the moldable material 114.

It will be appreciated that the mandrels 104 and 106 may be parts of a single mandrel, used for molding both of the substrates 64 and 74. Also, it will be appreciated that the mandrels 104 and 106 can be used in a large variety of molding operations to form the substrates 64 and 66. Such operations include raising the moldable material 114 above its glass transition temperature, but below its melting temperature, for example as described above. Alternatively the molding to form the substrates 64 and 74 may include liquefying the moldable material 114 in a suitable molding process, for example injection molding. As another alternative, the mandrels 104 and 106 may be stamped into softened moldable material 114.

After the moldable material 114 is properly shaped on the mandrels 104 and 106, the material 114 is then cooled and removed from the mandrels 104 and 106. This produces the substrates 64 and 74.

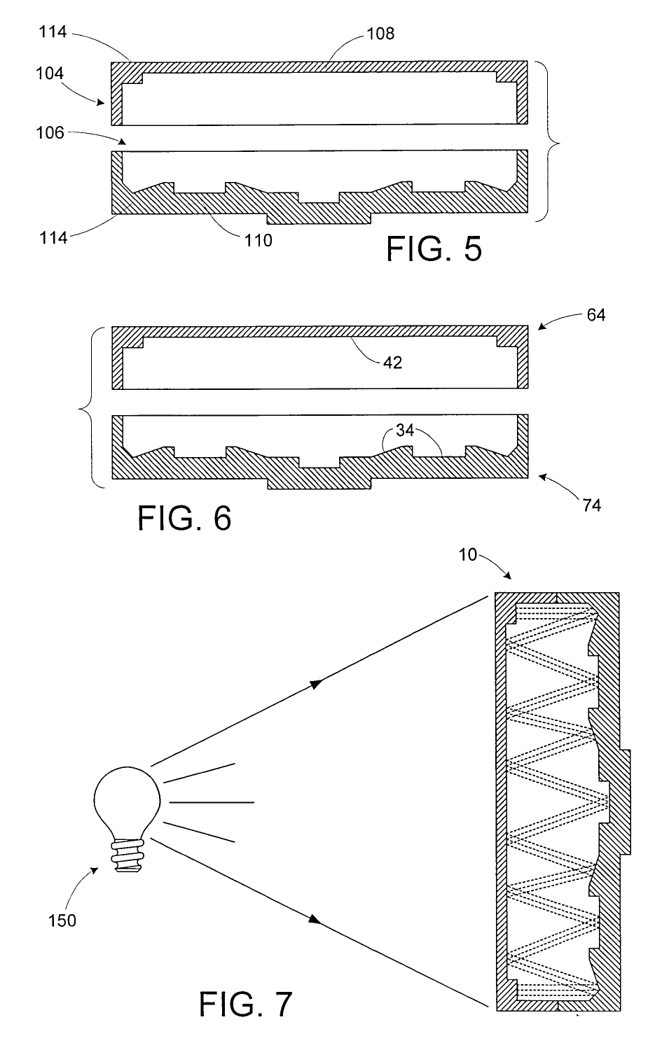

In step 118 reflective material is deposited onto selected surfaces of the substrates 64 and 74. This step, illustrated in FIG. 6, involves depositing a suitable metal or other reflective material to produce the bottom half reflective surfaces 34 and the top half reflective surface 42. The reflective material may be deposited by any of a variety of suitable deposition methods, one example being vapor deposition.

Finally, in step 120, the top half 16 is joined to the bottom half 18 along the join line 20, to produce the finished optical device 10 shown in FIG. 1. The halves may be joined by use of an adhesive that is suitable for bonding the materials used in the substrates 64 and 74. Alternatively other suitable methods, such as welding or bonding, may be used to join together the halves 16 and 18.

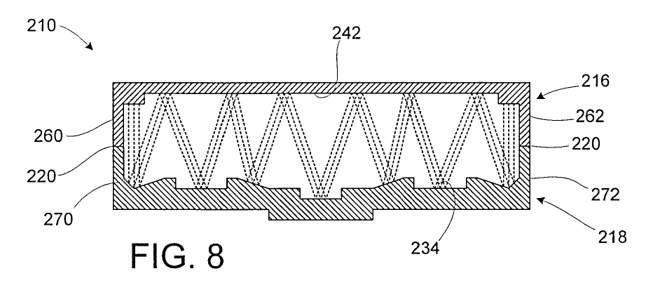

FIG. 7 shows the optical device 10 being used to focus light from an object 150. The device 10 produces large reductions in mass and volume required, relative to traditional optics such as lenses.

FIG. 8 shows an alternative embodiment, an optical device 210 which has a top half 216 and a bottom half 218 each made out of a single piece of material. The material for the top half 216 and the bottom half 218 may be a suitable metal. The metal for the halves 216 and 218 may be shaped by suitable processes, such as machining, in order to form hollows that together form an internal enclosed volume 212. One example of a suitable machining process is diamond turning.

Interior surfaces of the halves 216 and 218 may be polished to create a top half reflective surface 242 and bottom half reflective surfaces 234. Sides 260, 262, 270, and 272 of the halves 216 and 218 may be joined at a join line 220 by a suitable method, such as soldering or welding.

The optic 210 may cost more to manufacture than the optical device 10 (FIG. 1). However, the structure 214 of the optical device 10 may be stronger than the corresponding structure 14 (FIG. 1) of the optical device 10. In addition, the surfaces of the optical device 210 may be located with greater precision than those of the optical device 10.

Other features of the optical device 210 may be similar to those of the optical device 10. Advantages in use of the optical device 210 may be similar to those described herein with regard to the optical device 10.

It will be appreciated that many configurations are possible for folded optical devices. Also, such optical devices may be configured with a wide variety of other optical devices, such as lenses, mirrors, cameras, and image capture devices.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. An optical device comprising:
a structure defining a substantially enclosed volume, wherein the structure has an entrance aperture for receiving incoming light, and an exit aperture; and
reflective surfaces on opposite walls of the structure, wherein the reflective surface reflect and focus the incoming light multiple times along a light path from the entrance aperture to the exit aperture;
wherein the enclosed volume is taken up by a non-solid.

2. The optical device of claim 1,
wherein the structure is circular;
wherein the entrance aperture is an annular entrance aperture; and
wherein the exit aperture is a central exit aperture.

3. The optical device of claim 1, wherein the structure is made of a non-metallic material.

4. The optical device of claim 3, wherein the non-metallic material includes a polymer.

5. The optical device of claim 3, wherein the non-metallic material includes a glass.

6. The optical device of claim 3, wherein the reflective surfaces are metal surfaces deposited on interior faces of the structure.

7. The optical device of claim 1, wherein the structure is a molded structure.

8. The optical device of claim 1, wherein the structure is a machined structure.

9. The optical device of claim 1, wherein one of the reflective surface is the only reflective surface on one of the walls.

10. The optical device of claim 9, multiple angled reflective surfaces on the other of the walls.

11. The optical device of claim 1, wherein the structure includes a top half that includes one of the walls, and a bottom half that includes the other of the walls.

12. The optical device of claim 11, wherein the halves are attached together along a join line.

13. The optical device of claim 1, wherein the reflective surfaces include reflective material deposited on faces of the walls.

14. The optical device of claim 1, wherein the reflective surfaces are polished faces of the walls.

15. The optical device of claim 1, wherein the non-solid includes an aerogel.

16. A method of making an optical device, the method comprising:
forming a top half of the optical device structure by:
placing top half moldable material in contact with a top half mandrel having a shape corresponding to a desired top half inner face configuration of a top wall of the optical device;
molding the top half moldable material to correspond to the shape of the top half mandrel;
cooling the top half moldable material; and
removing the top half moldable material from contact with the mandrel;
forming a bottom half of the optical device structure by:
placing bottom half moldable material in contact with a bottom half mandrel having a shape corresponding to a desired bottom half inner face configuration of a bottom wall of the optical device;
molding the bottom half moldable material to correspond to the shape of the bottom half mandrel;
cooling the bottom half moldable material; and
removing the bottom half moldable material from contact with the mandrel;
depositing reflective material on one or more top half inner faces of the top half and one or more inner faces of the bottom half; and
joining together the top half and the bottom half with the one or more top half inner faces facing the bottom half inner faces.

17. The method of claim 16, wherein the depositing reflective material includes depositing aluminum.

18. The method of claim 16, further comprising heating the mandrels above a glass transition temperature prior to or during the placings.

19. The method of claim 16, wherein the moldings includes indirectly or directly heating the molded material above its glass transition temperature.

20. A method of handling an optical device, the method comprising:
providing the optical device, wherein the optical device includes:
a structure defining a substantially enclosed volume, wherein the structure has an entrance aperture for receiving incoming light, and an exit aperture; and
reflective surfaces on opposite walls of the structure, wherein the reflective surface reflect and focus the incoming light multiple times along a light path from the entrance aperture to the exit aperture;
filling the enclosed volume of the optical device with liquid;
subjecting the optical device to a hazardous situation while still filled with the liquid; and
emptying the liquid from the optical device.
